(19) United States
(12) Patent Application Publication
(10) Pub. No.: US 2014/0025800 A1
(43) Pub. Date: Jan. 23, 2014

(54) SYSTEMS AND METHODS FOR MULTI-BLADE LOAD BALANCING

(71) Applicant: Prashant Sharma, San Diego, CA (US)

(72) Inventor: Prashant Sharma, San Diego, CA (US)

(73) Assignee: RADISYS CORPORATION, Hillsboro, OR (US)

(21) Appl. No.: 13/555,984

(22) Filed: Jul. 23, 2012

(51) Int. Cl. G06F 15/16

(52) U.S. Cl. 709/223

(57) ABSTRACT

A method for load balancing by updating session information in a multi-blade load balancer is disclosed herein. The method may include distributing information about a local session table by a blade in the multi-blade load balancer to at least one other blade in the multi-blade load balancer. The method may also include updating a local session table by the at least one other blade on receiving the distributed information. The method may also include session table update for protocols including a control plane and data plane component.

### TECHNICAL FIELD

The present disclosure relates to communications networks and, more particularly, to multi-blade load balancing in computer networks.

### BACKGROUND

In a computer communication network, it is often useful to distribute a load equally among network components. For example, a computer network may include a plurality of servers. If the load is unevenly distributed among the servers, some servers may get overloaded whereas other servers may not be used to their maximum capability. In order to overcome the issue of uneven load distribution, a process called load balancing is may be implemented. Load balancing helps to distribute the workload across multiple computers, a computer cluster, network links, central processing units, disk drives, or other resources. Further, equal distribution of the load using load balancing helps to achieve optimal resource utilization, improved throughput, and minimal response time and also helps to avoid overloading of system components.

Generally, a load balancing service is provided by dedicated hardware or software, such as a multi-layer switch or a domain name server. Load balancing methodologies in advanced telecommunications computing architecture (ATCA) systems make use of blades associated with a load balancing module to perform load balancing such that each application blade handles a pre-set capacity/load in the network.

Presently, demand for large network services has increased disproportionately with the underlying infrastructure to support the demand. It is not uncommon for users to wait for a minute or more before they can get any information from the high traffic web servers. This wasted time and effort represents a loss of productivity for network users and can result in revenue losses that are particularly undesirable for commercial Internet web sites. It is essential that load balancing products strive to distribute a given set of incoming packet flows fairly to a set of target servers.

An existing load balancing system may balance a load based on connections per server in a multi-blade system. A network device in this system includes a plurality of blades which further include CPU cores in order to process requests received by the network device. The system includes a plurality of accumulators of which one is a master accumulator and the others are slave accumulators. The master accumulator circuit aggregates sets of aggregated local counter values from the slave accumulators to create a set of global counter values. The global counter values from the master accumulator are then transmitted to a management processor first and then to the CPU cores located on the blade and to the slave accumulators. A disadvantage of this method is that it does not disclose any system for effectively transmitting parameters across the network components.

Another existing method for load balancing achieves load balancing in the network by implementing a single address mechanism. In this method, a source specific join allows each of the plurality of servers to specify a source Internet protocol address range that each of the plurality of servers services. This method includes reallocating a source Internet protocol address range specified for at least one of the plurality of servers using a load balancing policy. Further, the method allows controlling a channel while at least one of the servers is handling communications. However, a disadvantage of this system is that the system is not able to identify or track load information in each of the associated servers. As a result, some servers may get overloaded, whereas capacity of other servers may not be fully utilized. Further, the system fails to effectively track and identify as to which server data is to be forwarded. The system also does not disclose any process of effectively identifying load on servers available in the network. This in turn can result in uneven distribution of loads on the servers, as the system is not aware of the load on each of the servers.

Another disadvantage associated with existing load balancer systems is that when they handle protocols with a control plane and a data plane, they fail to make load balancing decisions based on a control plane message and thereby also fail to route data and control planes to the same blade. In this case, correct load balancing decisions on a data plane can only be made by analyzing the control plane message for connection establishment, modification, and/or deletion.

### SUMMARY

In view of the foregoing, one embodiment herein provides a method for load balancing by updating session information in a multi-blade load balancer. The method may include distributing information about a local session table by a blade in the multi-blade load balancer to at least one other blade in the multi-blade load balancer. The method may also include updating a local session table by the at least one other blade on receiving the distributed information.

Also, disclosed herein is a multi-blade server for load balancing. The server may include a blade having means for distributing information about a local session table by a first blade in the server to at least one other blade in the server. The at least one other blade may include means for updating a local session table on receiving the information.

These and other aspects of the embodiments herein will be better appreciated and understood when considered in conjunction with the following description and the accompanying drawings.

### BRIEF DESCRIPTION OF THE DRAWINGS

The embodiments herein will be better understood from the following detailed description with reference to the drawings, in which:

FIG. 1 illustrates an example system environment of a load balancer in communication with multiple application servers, as disclosed in certain embodiments herein;

FIG. 2 is a block diagram illustrating a load balancer distributing packet flow in a network, as disclosed in certain embodiments herein;

FIG. 3 illustrates an example environment in which a plurality of load balancer blades are connected to a plurality of application servers, as disclosed in certain embodiments herein;

FIG. 4 illustrates a protocol message flow diagram in which control plane and data plane traffic are coordinated by a load balancer, as disclosed in certain embodiments herein;

FIG. 5 illustrates a flow diagram of a method for updating and distributing session table information, as disclosed in certain embodiments herein; and

FIG. 6 illustrates an example diagram depicting data flow in a multi-blade load balancer network, as disclosed in certain embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the example embodiments. The examples used herein are intended merely to facilitate an understanding of ways in which the embodiments herein may be practiced and to further enable those of skill in the art to practice these and other embodiments. Accordingly, the examples should not be construed as limiting the scope of the embodiments or the claims set forth herein.

The present disclosure relates to computer networks and, more particularly, to load balancing. In one embodiment, a multi-blade load balancing system maintains separate session tables with each blade associated with the load balancer. Whenever a new flow is added or removed from the session table of a blade, that information may be updated in the session table local to that particular blade. The same information may be distributed among other blades in the load balancer using any suitable distribution mechanism and the blades which receive the distributed information may update their local session tables with the received information. This may result in a global session table concept in which each blade in the load balancer maintains the same information in their session tables.

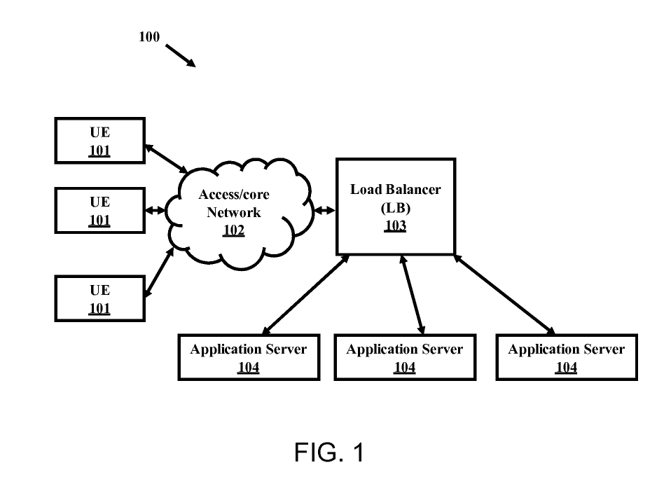

The embodiments disclosed herein include a multi-blade load balancing system that distributes session table information among other blades or nodes present in the network. The session table information may include information regarding traffic based on a protocol that includes a data plane and a control plane. With reference now to the drawings, and more particularly to FIGS. 1, 2, 3, 4, 5 and 6, example embodiments of load balancing systems and methods will be described. It should be noted that similar reference characters and numbers denote similar, not necessarily identical, corresponding features.

FIG. 1 illustrates an example environment of a load balancing system 100, as disclosed in certain embodiments herein. The depicted system 100 includes a plurality of user equipments (UEs) 101, an access/core network 102, a load balancer (LB) 103, and a plurality of application servers (AS) 104. In one embodiment, the load balancer 103 may be implemented for protocols that possess a control plane and a data plane component. Each UE 101 may be a mobile device connected to the network 102 for multimedia communication or may be any other communication device that is connected to other communication devices in the network 102 for exchange/sharing of data/information. The network 102 may be an access and/or a core network and may be any wireless or wired network such as second-generation wireless telephone technology (2G), third-generation mobile telecommunications (3G), Wi-Fi, long term evolution (LTE), and so on.

In one embodiment, the load balancer (LB) 103 balances distribution of loads. For example, the load balancer 103 may balance data and control traffic between the UE 101 and the plurality of application servers 104. In one embodiment, the data traffic may include a message, a voice communication, data, and so on between at least two network elements in the data plane.

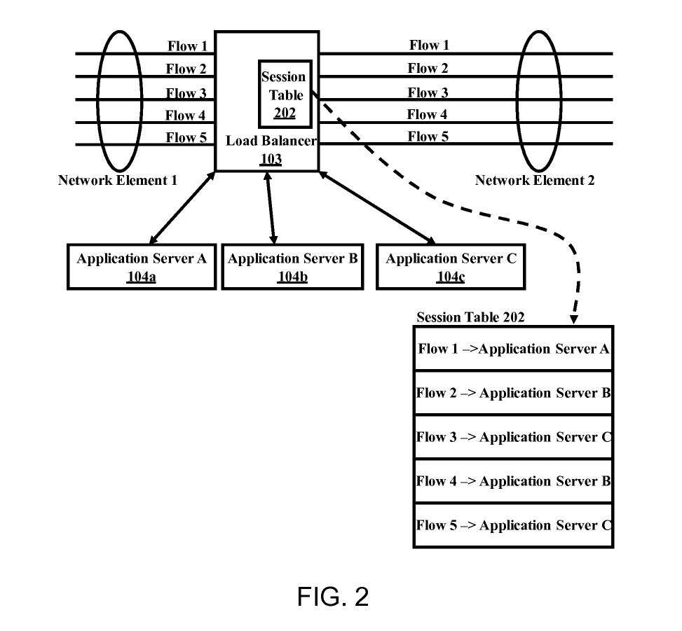

FIG. 2 illustrates a block diagram of a load balancer 103 distributing packet flow in a network, as disclosed in certain embodiments herein. The LB 103 may receive data flows from various network elements and/or nodes present in the network. The LB 103 may maintain the context of all flows in at least one database associated with the LB 103. The database may be a session table 202 and the LB 103 may select a target application server 104 from among application server A 104a, application server B 104b, and application server C 104c for each new flow based on information presented in the LB 103. The session table 202 may include at least a set of entries, such as a flow identifier and a corresponding target identifying an application server 104. For example, the AS 104 may be an AS 104 with which that particular data flow is configured. The flow identifier may be unique for each data flow.

In one embodiment, whenever a new data flow is assigned to an application server 104, a corresponding entry may be created in the session table 202 indicating the flow identifier of that particular data flow. Additionally, an identifier identifying a corresponding AS 104 to which the data flow is assigned may also be created in the session table 202. For example, each data flow, Flows 1-5 illustrated in FIG. 2, is shown assigned to one of the application servers, Application Servers A-C in FIG. 2, within the session table 202. Furthermore, the session table 202 entries may be modified or deleted when flow modification or deletion events are detected by LB 103. In one embodiment, the LB 103 may not restrict the AS 104 as monitoring boxes or inline network elements. The AS 104 may be present in the backend and may handle flow received from the LB 103.

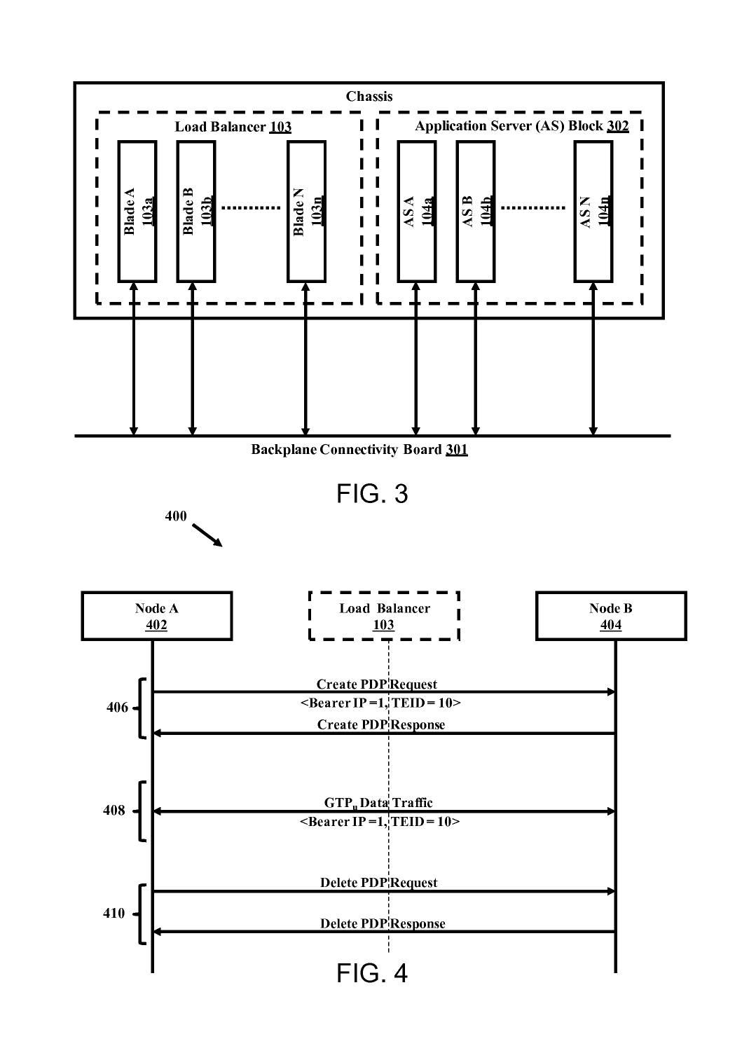

FIG. 3 illustrates an example environment in which a plurality of load balancer blades 103a-n are connected to the plurality of application servers 104a-n, as disclosed in certain embodiments herein. When network load increases beyond set limits, more infrastructure, such as servers and other such components, may be required to handle the increasing load. Increasing network load implies that a load balancer, itself, may need to be scaled up. In the example environment of FIG. 3, the LB 103 is a multi-blade load balancer that comprises multiple blades including blade A 103a, blade B 103b, and up to blade N 103n. Each blade 103a-n may be capable of handling a set amount of load. Each blade 103a-n may effectively be a computing system with one or more CPU's and associated memory and can handle a set amount of traffic. The application server block 302 includes a plurality of application servers including AS A 104a, AS B 104b, and AS N 104n.

In one embodiment, the blades 103a-n and the application servers 104a-n are connected through a backplane connectivity board 301. The number of blades 103a-n in the LB 103 may be changed (such as by adding or removing a blade), based on the amount of traffic to be supported. In various embodiments, the number of blades 103a-n and the AS 104a-n may be the same or may be different in the chassis. Each blade 103a-n may be connected to at least one of the AS 104a-n. In one embodiment, the multi-blade load balancer 103 and the plurality of application servers 104a-n may be present in the same location, i.e., within a single chassis or, in another embodiment, may be located in different locations. Furthermore, the blades 103a-n and the application servers 104a-n may be connected via the backplane connectivity board 301 through any suitable means for data transfer, such as Ethernet and/or any such means.

Each blade 103a-n in the LB 103 may maintain separate session tables. For example, each blade 103a-n may maintain its own local session table. In one embodiment, a session table may be maintained in a memory module associated with the LB 103, such as a memory module associated with a blade 103a-n. In one embodiment, memory of a memory module may be local to a specific blade 103a-n associated with the LB 103. For example, each blade 103a-n may include a separate memory module. In various embodiments, the information stored in the session table associated with each blade 103a-n may or may not be accessible to other blades in the LB 103.

FIG. 4 illustrates a protocol message flow diagram 400 in which control plane and data plane traffic are coordinated by a load balancer 103, as disclosed in certain embodiments herein. In one embodiment, a load balancer 103 may be used for protocols that have a control and a data plane split, that is, for protocols that possess at least one control plane and one data plane. The example, as shown in FIG. 4, illustrates example control plane and data plane coordination for general packet radio service (GPRS) tunneling protocol (GTP). GTP is a protocol which includes a control plane protocol (GTPc) and a data plane protocol (GTPu).

Generally, GTPc is used to establish, modify, and/or delete GTPu flows. For example, consider a case in which GTP data flow is to be established between node A 402 and node B 404 of FIG. 4. The nodes 402-404 may be network elements such as user equipment 101, application servers 104, and so on. Further, the protocol message flow diagram 400 as depicted in FIG. 4 may be applicable for other protocols, such as session initiation protocol (SIP), real-time transport protocol (RTP), GTPu, S1 application protocol (S1AP), or any other protocol that includes control plane and data plane components. In general, control plane protocols are used to negotiate and/or establish flow parameters and data plane protocols use the negotiated/established flow parameters during data transfer. In one embodiment, a load balancer 103 may need to monitor all control plane traffic to find out when new flows are established, modified, and/or deleted and select a target AS 104 for each new flow. The load balancer 103 may then update a session table 202 that maps data flows to target application servers 104.

The control plane protocols may be used to negotiate and/or establish flow parameters and data plane protocols use the negotiated and/or established flow parameters during data transfer. For example messages sent during periods 406 and 410 may include control plane messages while messages sent during period 408 may include data plane messages. For example, the “Create packet data protocol (PDP) request) sent during period 406 and the “Delete PDR Request” sent during period 410 may correspond to a control plane protocol. The “GTPu Data Traffic” may correspond to a data plane protocol. In one embodiment, the LB 103 may have to monitor all control plane traffic to find out when new flows are established, modified, or deleted and select a target application server 104 for each new flow. Any information regarding assigning or deleting flows with any blade may be updated in the session table 202.

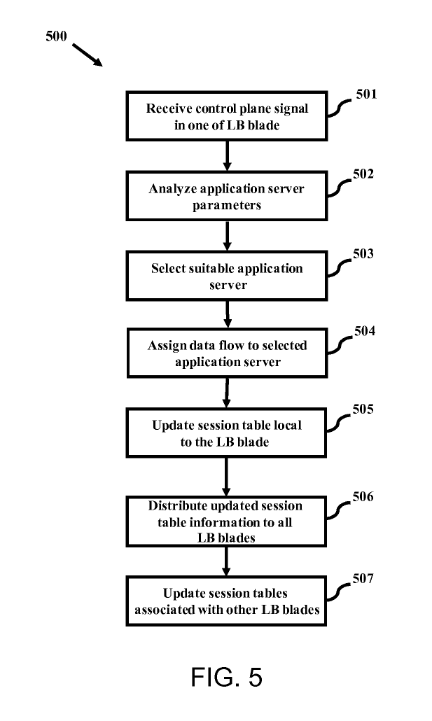

FIG. 5 illustrates a flow diagram of a method 500 for updating and distributing session table information, as disclosed in certain embodiments herein. In the case of protocols that have control and data planes, a network element may initiate a data transfer or exchange by sending a control plane message in a data flow to another network element with which it wishes to establish a connection. The network element may be a UE 101 or any other network component that is capable of sending and/or receiving data across the network.

Control plane messages to create a new session may be received by a given LB blade (step 501). When any of the blades in the LB 103 receives (step 501) a new control plane, it may check the status of all application servers AS 104. In one embodiment, the status of all AS 104 may be checked by analyzing information present in the session table associated with the AS 104. In another embodiment, the status of AS 104 may refer to information, such as information about loads being handled by each AS 104, information about data flows that have been assigned to each of the AS 104, and so on.

The LB 103 may analyze (step 502) parameters associated with each AS 104 so as to identify the status of each AS 104 present in the network. The LB 103 may select (step 503) one of the AS 104 in the network so as to assign the received control plane and associated data plane messages to the AS 104. In one embodiment, the LB 103 may use load balancing logic to decide which AS 104 should be assigned to a new control plane. The load balancer 103 may consider, as part of load balancing logic example factors such as loads being handled by each of the AS 104, data flow assigned to each blade 103a-n, and so on, in order to select a blade to which to assigning the new data flow. Further, data and/or load capacity of each of the AS 104 and associated hardware may also be considered in this process.

Once a suitable AS 104 is selected (step 503) by the LB 103, the LB 103 may assign (step 504) the control plane of the received data flow to the selected AS 104. While assigning the control plane of any data flow to an AS 104, a virtual communication path may be established between that AS 104 and the network node, element, or UE 101 which is the source of that particular data flow. The virtual communication path may be such that any further data flow from the source network element may get routed to that particular AS 104 through the established path. Furthermore, a blade 103a-n of the LB 103 may update (step 505) information regarding new connection establishment in a session table 202 local to it.

The blade 103a-n of the LB 103 distributes (step 506) information on the new entry in the local session table 202 among other blades associated with the LB 103. This enables all blades 103a-n of the LB 103 to forward all control and data plane messages for this flow towards the selected AS 104. Distribution of information in the network may be performed using any suitable technique or scheme, such as multicasting, broadcasting, and so on.

Upon receiving the distributed information, other blades in the network update (step 507) session table 202 information local to each of the blades. In an embodiment, the process of receiving distributed information and updating local session tables 202 of each blade 103a-n results in all blades 103a-n maintaining the same information. For example, the separate session tables 202 may effectively act virtually as a global session table. Further, the LB 103 may be able to refer to the session table 202 data to get information such as the load being handled by each blade, data flow assigned to each blade, and so on.

In one embodiment, once a data transmission is over, a communication path may be deleted by sending a suitable delete trigger message by the network element, such as “Delete PDP Request” of FIG. 4. Upon receiving the delete trigger, the blade 103a-n may update the same in its own local session table. That is, the entry corresponding to that particular flow may be removed from the session table 202. Further, information regarding the delete trigger may be distributed among other blades in the same network, for example, the blades which are associated with the same LB 103. A suitable technique or scheme, such as multicasting, broadcasting, and so on may be used to distribute the information among other blades in the network. Upon receiving the information, the blades may remove the corresponding entry from their respective session tables 202.

The various actions and steps 501-507 in method 500 are examples only and may be performed in the order presented, in a different order, or simultaneously. Further, in some embodiments, some of the actions or steps 501-507 listed in FIG. 5 may be omitted.

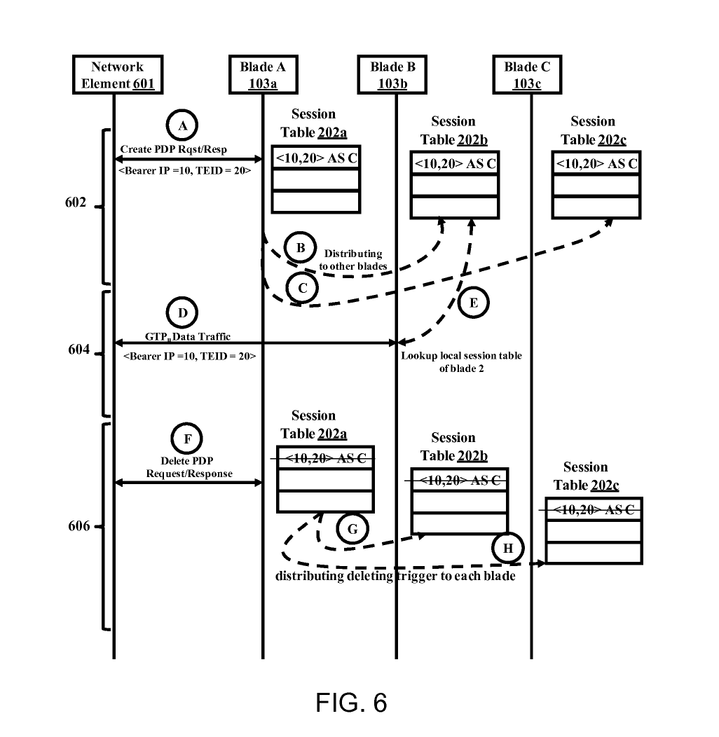

FIG. 6 is an example diagram illustrating data flow and session table updates in a multi-blade load balancing system 100, as disclosed in certain embodiments herein. For example, consider data flow according to the GTP protocol. The GTP protocol suite includes two planes, namely the control plane protocol (GTPc) and the data plane protocol (GTPu). The GTPc is used to establish a connection and the GTPu refers to the data being transmitted between the network elements. The network element 601 may be a UE 101 or any such network component. In one embodiment, the network element 601 that initiates the data transfer may transmit the data to the LB 103 and may not be aware of the backend application server 104 that receives and processes the data. The data may be a message, audio data, video data, and so on.

Initially, during period 602, the network element 601 makes a connection request (A) by means of a “Create packet data protocol (PDP) request.” The Create PDP request is a control plane protocol (GTPc) message. In one embodiment, the GTPc message includes identity parameters, such as a tunnel endpoint identifier (TEID), bearer internet protocol (IP) address, and so on. In one embodiment, the identity parameters are unique parameter values. In the example of FIG. 6, a bearer IP equals 10 and a TEID equals 20. In one embodiment, the TEID and bearer IP values may be the same for a control plane (GTPc) and corresponding data plane (GTPu). For example, all data plane messages within a given flow may include the same TEID and bearer IP values.

In one embodiment, the LB 103 blade A 103a receives the “Create PDP request” message and selects an applicable AS 104 for this flow. Blade A 103a may then update its local session table 202a with the identity parameters received in the message, <10, 20>, and the selected application server, indicated as AS C. Further, the data updated in the local session table 202a of blade A 103a is distributed (B) and (C) among other blades 103b and 103c associated with the load balancer 103 using a suitable distribution scheme.

Upon receiving the distributed information, the other blades 103b and 103c update their local session tables 202b, 202c with the received information. Later, during period 604 when a data plane message reaches (D) blade B 103b, or any blade in the LB 103, it checks (E) session table 202b information to identify the AS to which the received data plane message is to be routed. In an embodiment, the identity parameter values associated with the data plane may be compared with the information present in the session table 202b. This may allow blade B 103b to identify which application server should handle the message. The data plane message may then be routed to the identified AS C.

Once data transfer is complete, an established communication path may be terminated. In order to terminate the communication, the network element 601 sends a termination request, such as “delete PDP request,” to a blade during period 606. Note that any of the blades may be capable of receiving a delete request. Upon receiving this request, blade A 103a removes the corresponding entry from its local session table 202a. Further, blade A 103a distributes (G) and (H) the information or delete trigger to the other blades 103b, 103c associated with the LB 103. Upon receiving this information, blades 103b, 103c also remove the corresponding entry from associated local session tables.

Certain embodiments disclosed herein may be implemented through at least one software program running on at least one hardware device and performing network management functions to control the network elements. The network elements shown in FIG. 3 include blocks which can be at least one of a hardware device, or a combination of a hardware device and a software module.

Certain embodiments herein specify a system for multi-blade load balancing. The mechanism allows load balancing in a communication network, providing a system thereof. Therefore, it is understood that the scope of the protection is extended to such a program, in addition to a non-transitory computer readable storage medium having a message or computer executable instructions stored therein. Such a computer readable storage medium may include the program code for implementation of one or more steps of a method described herein, when the program runs on a server or mobile device, or any suitable programmable device. The method is implemented in certain embodiments through or together with a software program written in, e.g., very high speed integrated circuit hardware description language (VHDL), another programming language, or implemented by one or more VHDL or several software modules being executed on at least one hardware device. The hardware device can be any kind of device that can be programmed including, e.g., any kind of computer like a server or a personal computer, or the like, or any combination thereof, e.g., one processor and two field programmable gate arrays (FPGAs). The device may also include means that could be, e.g., hardware means like, e.g., an application specific integrated circuit (ASIC), or a combination of hardware and software means, e.g., an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g., using a plurality of central processing units (CPUs).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should be and are intended to be comprehended within the meaning and range of equivalents of the disclosed embodiments. It is to be understood that the phraseology or terminology employed herein is for the purpose of description and not of limitation. Therefore, while the embodiments herein have been described in terms of example embodiments, those skilled in the art will recognize that the embodiments herein can be practiced with modification within the spirit and scope of the claims as described herein.

What is claimed is:

1. A method for load balancing by updating session information in a multi-blade load balancer, said method comprising:
distributing information about a local session table by a blade in said multi-blade load balancer to at least one other blade in said multi-blade load balancer; and
updating said local session table by said at least one other blade, on receiving said distributed information.

2. A method as claimed in claim 1, wherein said updating session table is used for protocol that comprise at least one control plane and a data plane.

3. The method, as claimed in claim 1, wherein said blade distributes information in response to a change being made in a local session table belonging to said blade.

4. A multi-blade server for load balancing, said server comprising:
a first blade comprising: a means for distributing information about a local session table by said first blade to at least one other blade in said server; and
at least a second blade comprising: a means for updating said local session table in response to receiving said information.

5. The server, as claimed in claim 4, wherein said first blade is configured for distributing information on a change being made in a local session table belonging to said first blade.
